(19) United States
(12) Patent Application Publication
(10) Pub. No.: US 2014/0345958 A1
(43) Pub. Date: Nov. 27, 2014

(54) LIGHTWEIGHT POLYCARBONATE SUSPENSION FOR VEHICLE

(71) Applicant: Gary Kenneth Lavarack, Sausalito, CA (US)

(72) Inventor: Gary Kenneth Lavarack, Sausalito, CA (US)

(21) Appl. No.: 13/902,848

(22) Filed: May 26, 2013

(51) Int. Cl. B60G 11/08; B60K 7/00

(52) U.S. Cl. CPC B60G 11/08; B60K 7/0007
USPC 180/55; 280/124.171

(57) ABSTRACT

A lightweight suspension system for vehicles comprised of resilient polycarbonate plastic is disclosed. The system includes front and rear suspension components for four wheeled electric vehicles.

### FIELD OF THE INVENTION

The present invention relates generally to a lightweight suspension system, and more specifically relates to suspensions suited for electric vehicles and a vehicle for employing the same.

### BACKGROUND OF THE INVENTION

Motor vehicle suspension system designs typically come in the form of metal double wishbones, springs, shocks, and struts. Such embodiments generally include a large number of individually manufactured components, and often require extensive time and numerous tools to assemble. Notably, the assembly of shocks and struts can also be dangerous, and specials tools are needed to avoid injury.

### SUMMARY OF THE INVENTION

A lightweight suspension system for vehicles is disclosed. The apparatus comprises, one or more leaf springs that span the width of the vehicle between opposing wheel hubs. In one embodiment, the one or more plastic leaf springs are made from resilient polycarbonate plastic. A lightweight vehicle chassis can encompass the suspension and all other internal system components.

A typical leaf spring can either be attached directly to the frame at both ends or attached directly at one end, usually the front, with the other end attached through a shackle, a short swinging arm. The shackle takes up the tendency of the leaf spring to elongate when compressed and thus makes for softer springiness. Some springs terminated in a concave end, called a spoon end (seldom used now), to carry a swiveling member.

In one embodiment, the present invention improves at least some of the deficiencies associated with the manufacture of typical metal double wishbones, springs, shocks and struts by requiring fewer components to manufacture and considerable weight savings. The design may further be improved by mounting to a vehicle chassis with aluminum materials.

In another embodiment, the present invention provides a suspension system that includes permanently lubricated steering bearings, thereby requiring very low maintenance or adjustment.

In yet another embodiment, the present invention provides a suspension system that uses a double wishbone (upper and lower A-arms) manufactured from self-dampening polycarbonate plastic, which eliminates the need for heavy springs, supports, hydraulic shock absorbers and chassis supports in the mechanism.

A further aspect of the present invention includes steering forks for easy two bolt mounting of hub/wheel motor units, allowing easy assembly and removal of the wheel and tire. This facilitates routine tire rotation, repairing a flat tire, wheel maintenance, disc brake pad replacement and routine rotor turning.

Yet another aspect of the present invention includes a double wishbone suspension mechanism adapted to provide a vertical travel of at least eight inches depending on the application of the design.

Yet another aspect of the present invention provides independent movement of each wheel and tire in response to the terrain.

### BRIEF DESCRIPTION OF THE DRAWINGS

FIG. 1 is an exploded view of a preferred embodiment the invention;

FIG. 2 is a perspective view of an embodiment the invention in the neutral position;

FIG. 3 is a perspective view of an embodiment the invention in the up position;

FIG. 4 is a perspective view of an embodiment the invention in the down position;

FIG. 5 is a right side view of a single-occupant electric vehicle mounted on a suspension system according to one embodiment of the invention.

FIG. 6 is a rear view of the single occupant electric vehicle depicted in FIG. 5.

FIG. 7 is a front view of the single occupant electric vehicle depicted in FIG. 5.

### DETAILED DESCRIPTION OF EMBODIMENTS OF THE INVENTION

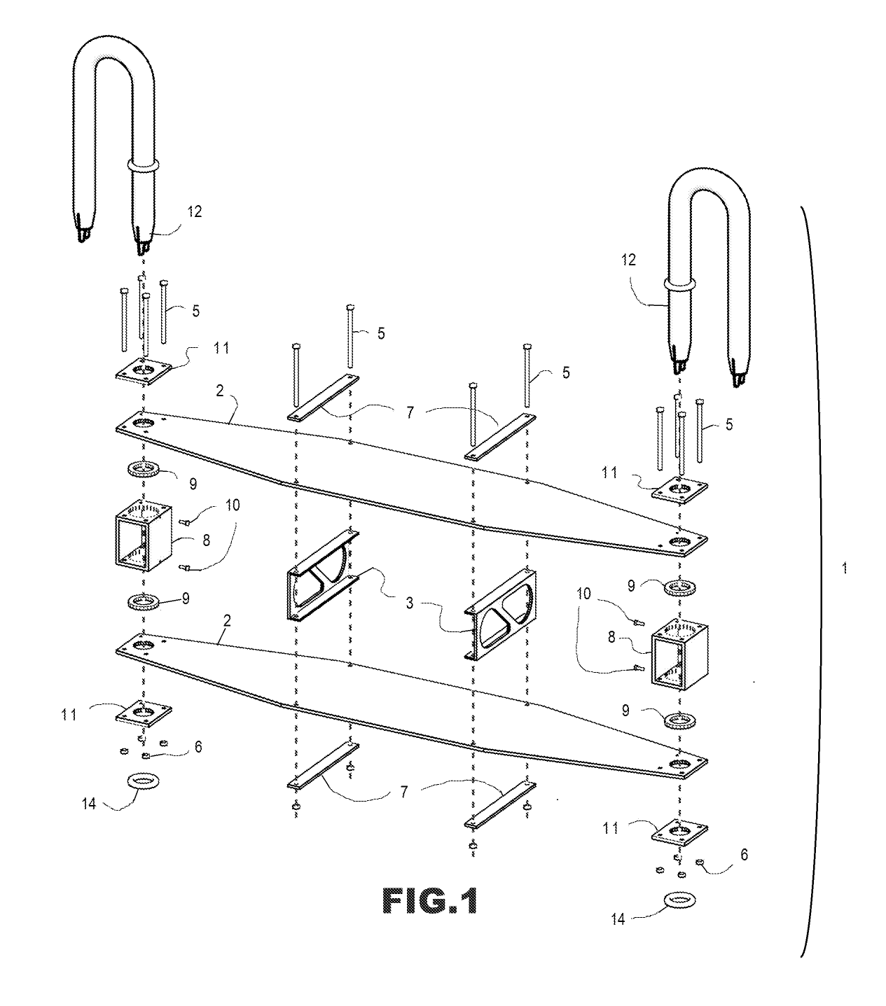

Referring to FIGS. 1-4, the suspension assembly 1 preferably comprises two resilient polycarbonate members 2 rigidly mounted together in a substantially parallel fashion to form a front or rear wheel suspension assembly 1. In the preferred embodiment, front and rear wheel suspension assemblies 1 are identical. This reduces cost and facilitates manufacturing. It is contemplated, however, that alternate configurations may comprise any other number of such polycarbonate members as required by the particular application or performance characteristics, and that the front and rear wheel suspension assemblies may differ from each other, as dictated by the particular application.

The polycarbonate members 2 are connected to one or more chassis mounting brackets 3 spaced across the length of the polycarbonate members 2. The mounting brackets 3 are secured or fastened to a chassis 4 (FIG. 1 shows mounting bolts 5, nuts 6 and hold down straps 7). The polycarbonate members 2 each act as a leaf spring to comfortably support the chassis 4 and occupants (not shown) during operation. Bearing mounting blocks 8 include upper and lower bearings 9, which are secured to the bearing mounting blocks 8 with set screws 10. The mounting blocks 8 are attached near the ends of the polycarbonate springs 2 with mounting bolts 4 and nuts 5 and top and bottom mounting plates 11. Tubular steering forks 12 for rotating the wheels 13 are inserted into the bearings 9 and are secured thereto with collets 14.

In the preferred embodiment, each of the polycarbonate member 2 leaves are composed of a Makrolon polycarbonate plastic (though other polycarbonates are contemplated to be suitable alternatives) and the supporting components are machined aluminum extrusions capable of attachment or modification to support any chassis 4 design. The chassis 4 in this embodiment is preferably made of aluminum, though traditional steel versions or other similarly suitable materials are also contemplated. The polycarbonate is cut into the elongate tapered shapes shown in the figures from flat or planar sheet stock and has only a few holes drilled in it for mounting purposes. In the preferred embodiment and in the prototype discussed below, the planar sheet stock used was ¼″ thick, though it is contemplated that the thickness and number of sheets may be modified to some degree to achieve the desired characteristics.

The shape shown is generally symmetrical along all orthogonal axes, elongated in a direction perpendicular to the direction of travel, and spans substantially the entire vehicle width. The cut edges are finished for a cosmetic appearance. Given the nature of the material, it is contemplated that alternate embodiments may comprise non-planar cross-sections such as “L” or “I-beam” cross-sections or any other shape deemed to be advantageous. The polycarbonate is able to deform under very heavy loads, yet upon removal of the load it can return to its original shape without any permanent deformation such as dents or scratches.

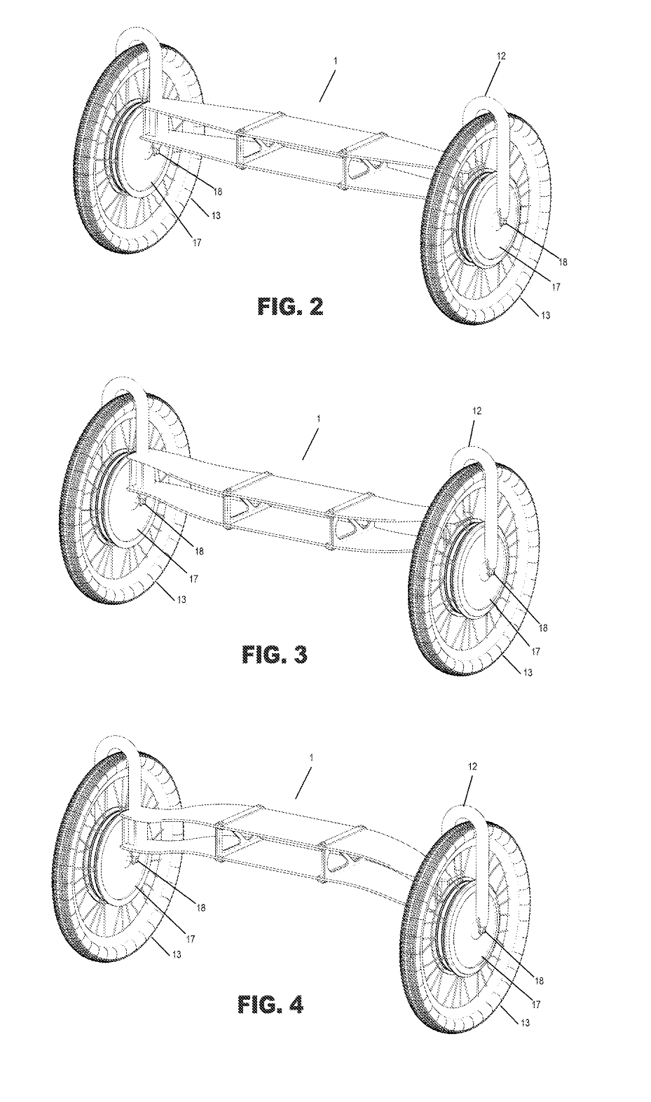

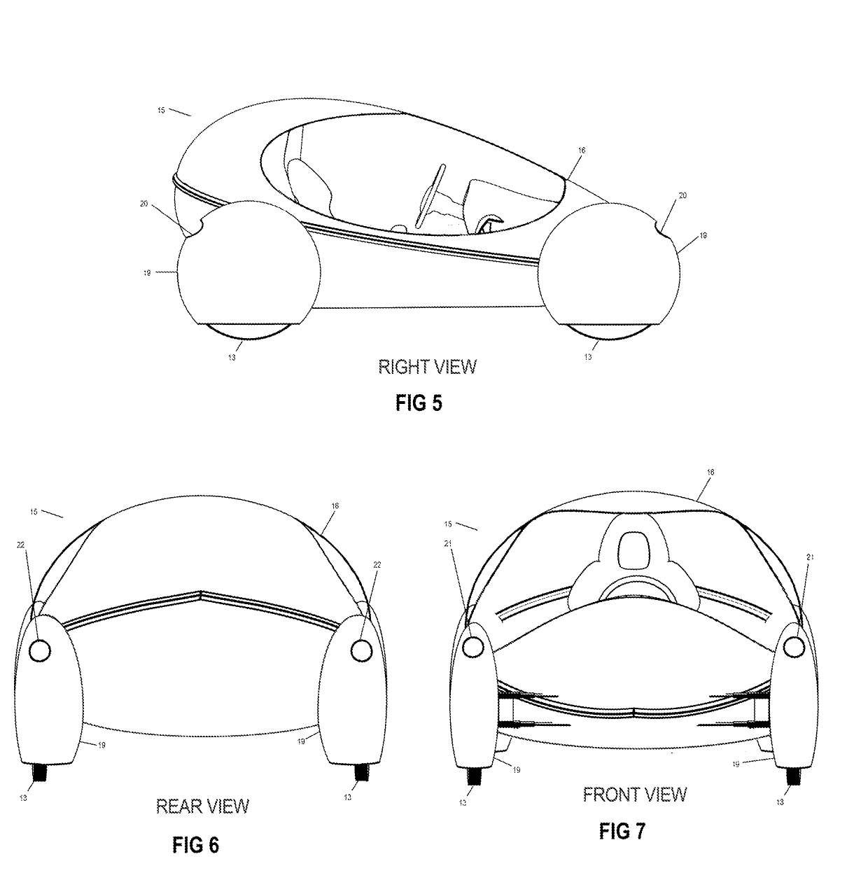

Referring to FIGS. 2-4, the suspension assembly 1 is shown in the “neutral”, “up”, and “down” positions, respectively. The neutral position depicts the device at rest supporting only the vehicle 15 and occupant(s). The up position depicts the suspension device as it might appear when the vehicle 15 is driven over an object (e.g. a speed bump). The down position shows the suspension assembly 1 as it would appear when the vehicle 15 encounters a pothole or the like.

Advantageously, the system is self-dampening. This is made possible because it is extremely light and has less mass compared to larger, heavier vehicles. Moreover, the system preferably utilizes permanently lubricated bearings, which require very low maintenance or adjustment.

Vehicle

Referring to FIG. 2, a lightweight vehicle chassis 4 is shown mounted on the suspension and drive system. The preferred embodiment comprises an electric or hybrid vehicle, though alternate types of vehicles are also contemplated such as standard gasoline or diesel internal combustion engines. The preferred embodiment further comprises a single seat for a single operator. An alternate embodiment contemplates that the present device may be easily modified into a ‘two-seater’ design. In the two-seat design, the suspension may be elongated horizontally to allow two occupants to sit in tandem. Alternatively, the two-seat design may be elongated in the direction of travel to permit a second occupant to sit behind the first. Embodiments having four or more seats carrying occupants are also contemplated and would more closely resemble a standard vehicle in certain respects.

The embodiment pictured shows the single seat design. In this preferred embodiment, the chassis 4 comprises a canopy 16 capable of opening to permit access to the interior of the vehicle 15. Alternate configurations are contemplated such as single or dual doors located on the front or sides of the vehicle 15. Dimensions vary depending on application and vehicle configuration. In the single seat embodiment shown, the polycarbonate suspension is approximately 48″ wide, 4″ tall and 9″ in depth. Both leaves are identical for facilitating and reducing the cost of manufacturing.

Also in this preferred embodiment, the vehicle is powered by four individual direct drive electric hub motors 17, each attached to one of the wheels 13. Hub motors 17 can themselves be an integral part of the wheel 13. They can be located in the structural center of the wheel 13 and include wheel bearings (not shown). Each hub motor 17 may provide power and rotate around its shaft 18. The shaft 18 of the hub motor 17, however, may not rotate in the direction of travel. It may instead be secured to a steering fork 12 and rotate with the wheels 13 when is turned by the respective steering fork 12.

This preferred embodiment uses no transmission, no belts, no chains, and no pulleys. Such a configuration is lightweight and capable of substantial power and responsiveness. The wheel shrouds 19 may also provide a distinct look as well as favorable aerodynamics. The embodiment shown also includes indentations 20 in the wheel shrouds 19 for headlights 21 and taillights 22.

It is contemplated that the presently disclosed suspension is ideally applied to a NEV (Neighborhood Electric Vehicle), but in view of its capabilities could potentially be configured for other lightweight vehicle applications. It is further contemplated that the device would be an attractive option for police and military uses. Such uses might benefit from further modifications that are contemplated in the present invention including alternate wheels/tires, thicker polycarbonate canopy and body as well as additional batteries for computers and communication gear. Further modifications can include any other vehicle equipment currently in use, lights, sirens, loudspeakers, radar, cameras or even weapons.Testing of a prototype has been accomplished using a NEV configuration that has been driven on all types of terrain with outstanding handling and steering properties. During operation of the prototype vehicle, it behaved as though the vehicle used a standard steel suspensions. Prototype performance met or exceeded expectation in regards to accelerating, handling, turning and braking. The present invention provides at least two advantages over prior art in that the polycarbonate material is considerably lighter and much easier to manufacture. Maintenance and replacement parts would also be far less expensive.

Advantageously, all other necessary components not explicitly described are capable of utilizing parts that are currently available including components from any and all vehicles on the market. These include rack and pinion steering, disc brakes, calipers, steering column and steering wheel. Components used for various iterations of the prototype included off-the-shelf components from automobiles, bicycles, scooters and motorcycles. It is further contemplated that any existing appropriate components may be used for those features not otherwise specified.

Polycarbonate Structure

The present invention contemplates the use of a polycarbonate material due to its lightweight and durable characteristics when used as described. Such a material has been used for bulletproof windows, aircraft windows, riot shields, security lighting, packaging, “glassware,” etc. Other useful features include temperature resistance, impact resistance and enhanced optical properties, all of which could be utilized by the present invention.

Unlike most thermoplastics, the suggested polycarbonate material can undergo large plastic deformations without cracking or breaking. As a result, it can be processed and formed at room temperature using sheet metal manufacturing techniques. Even for sharp angle bends with a tight radius, heating may not be necessary. This makes it valuable in prototyping applications where transparent or electrically non-conductive parts are needed, which cannot be made from sheet metal.

In the present application, injection-molded polycarbonate can produce very smooth surfaces that make it well suited for direct (without the need for a basecoat) metalized parts such as decorative bezels and optical reflectors. Its uniform mold shrinkage results in parts with greater accuracy than those made of polypropylene. However, due to its susceptibility to environmental stress cracking, its use has largely been limited to low-stress applications. In a laminated state, it can be laminated to make materials such as bulletproof “glass”, and such a state is one of the embodiments contemplated herein for higher-stress applications.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure as defined by the appended claims.

What is claimed is:

1. A lightweight suspension system for a four-wheel electric vehicle having a width and a length, the suspension comprising:
a front suspension assembly and a rear suspension assembly;
said front and rear suspension assemblies each comprising two or more elongated and substantially planar leaf springs secured together in a substantially parallel fashion;
wherein said two or more leaf springs are substantially identical to each another and substantially span the vehicle width; and
wherein said leaf springs comprise polycarbonate.

2. The suspension system of claim 1, wherein the suspension system is configured to support a single occupant neighborhood electric vehicle.

3. The suspension system of claim 1, wherein the suspension system is configured to support a dual-seat neighborhood electric vehicle.

4. The suspension system of claim 1, wherein the suspension system is configured to support four or more passengers.

5. The suspension system of claim 1, wherein a hub motor is connected on each side of the front suspension assembly.

6. The suspension system of claim 1, wherein a hub motor is connected on each side of the rear suspension assembly.

7. The suspension system of claim 1, wherein the suspension system is configured to support an aluminum vehicle chassis.

8. The vehicle suspension system of claim 1, wherein the suspension system supports a hybrid electric vehicle.

9. A lightweight vehicle suspension system comprising:
two front hub motors coupled by a front suspension assembly comprising two or more substantially planar and interconnected polycarbonate leaf springs; and
two rear hub motors coupled by a rear suspension assembly comprising two or more interconnected polycarbonate leaf springs;
wherein said front and rear suspension assemblies define a width, and the polycarbonate leaf springs substantially span the width of the front and rear suspension assemblies.

10. The vehicle suspension system of claim 9, wherein the suspension system supports a neighborhood electric vehicle.

11. The vehicle suspension system of claim 10, wherein the neighborhood electric vehicle is a single seat neighborhood electric vehicle comprising a canopy door.

12. The vehicle suspension system of claim 9, wherein the suspension system supports one of a steel or aluminum chassis.

13. A lightweight electric vehicle comprising:
a suspension system comprising a front suspension assembly and a rear suspension assembly; and
wherein said front and rear suspension assembly each comprises two hub motors coupled together by at least two substantially planar leaf springs.

14. The electric vehicle of claim 13, wherein the electric vehicle is a single occupant neighborhood electric vehicle.

15. The electric vehicle of claim 14, wherein the vehicle comprises a canopy door.

16. The electric vehicle of claim 13, wherein each of the two or more leaf springs are symmetrical along three orthogonal axes and are identical to each other.

17. The electric vehicle of claim 13, wherein the electric vehicle is dual seat neighborhood electric vehicle.

18. The electric vehicle of claim 13, wherein the electric vehicle comprises four or more seats.

19. The electric vehicle of claim 13, wherein said polycarbonate leaf springs are elongated and substantially span the entire vehicle width.

20. The electric vehicle of claim 13, wherein said vehicle comprises an aluminum chassis supported by the suspension system.
